(19) United States
(12) Patent Application Publication
(10) Pub. No.: US 2011/0254385 A1
(43) Pub. Date: Oct. 20, 2011

(54) DIRECT ACTING ROTATION ACTUATOR

(75) Inventors: Shogo Makino, Fukuoka (JP); Toru Shikayama, Fukuoka (JP)

(73) Assignee: KABUSHIKI KAISHA YASKAWA DENKI, Kitakyushu-shi (JP)

(21) Appl. No.: 13/041,445

(22) Filed: Mar. 7, 2011

(30) Foreign Application Priority Data
Apr. 14, 2010 (JP) 2010-093189
Jan. 12, 2011 (JP) 2011-004368

(51) Int. Cl. H02K 41/02

(52) U.S. Cl. 310/12.14

(57) ABSTRACT

A direct acting rotation actuator includes a motor unit, an output shaft, a detector unit, and a bearing portion. The motor unit includes a field magnet portion which includes a permanent magnet or a core tooth, a first armature winding which generates a rotation magnetic field in the rotation direction, and a second armature winding which generates a traveling magnetic field in the direct acting direction. The output shaft is attached to the field magnet portion of the motor unit. The detector unit includes a direct acting detector and a rotation detector respectively detecting a position in the direct acting direction and an angle in the rotation direction of the output shaft. The bearing portion includes a direct acting bearing and a rotation bearing respectively supporting the output shaft in the direct acting direction and the rotation direction. The motor unit is disposed on an anti-load side of the output shaft, and the detector unit is disposed on a load side of the output shaft.

### CROSS-REFERENCE TO RELATED APPLICATIONS

This application is based upon and claims the benefit of priority of the prior Japanese Patent Application No. 2010-093189, filed on Apr. 14, 2010; and Japanese Patent Application No. 2011-004368, filed on Jan. 12, 2011, the entire contents of all of which are incorporated herein by reference.

### FIELD

The embodiments discussed herein are directed to a direct acting rotation actuator.

### BACKGROUND

Both currently and in the past, there has been known a direct acting rotation actuator configured to perform both a rotation operation and a direct acting operation.

For example, the direct acting rotation actuator includes a stator and a mover. The stator includes armature windings for a rotation motor and a linear motor which concentrically overlap each other. The mover includes a field magnet portion such as a permanent magnet attached to around the output shaft. Accordingly, the direct acting rotation actuator directly generates a torque and a thrust force in the mover. Likewise, the portion generating a torque and a thrust force is called a “motor unit.”

Further, the above-described direct acting rotation actuator includes a “detector unit” which detects a rotation or a movement of the mover by using a direct acting rotation detector provided in the stator and a direct acting rotation scale provided around the output shaft of the mover.

Then, there has been proposed a direct acting rotation actuator in which the above-described “motor unit” is disposed on a load side and the above-described “detector unit” is disposed at an anti-load side. Such a related art technology is disclosed in, for example, Japanese Patent Application Laid-Open Publication No. 2007-143385.

However, the above-described direct acting rotation actuator is problematic in that there is still room for improvement in detection precision for a position in the direct acting direction and an angle in the rotation direction.

For example, in the above-described direct acting rotation actuator, since the “motor unit” is disposed between the “detector unit” and the load, there is a tendency that a distance between the “detector unit” and the load is large. For this reason, the output shaft may deform by heat generated from the “motor unit,” and this deformation may easily cause a detection error of the “detector unit.”

### SUMMARY

A direct acting rotation actuator according to an aspect of embodiments includes a motor unit, an output shaft, a detector unit, and a bearing portion. The motor unit includes a field magnet portion which includes a permanent magnet or a core tooth, a first armature winding which generates a rotation magnetic field in the rotation direction, and a second armature winding which generates a traveling magnetic field in the direct acting direction. The output shaft is attached to the field magnet portion of the motor unit. The detector unit includes a direct acting detector and a rotation detector respectively detecting a position in the direct acting direction and an angle in the rotation direction of the output shaft. The bearing portion includes a direct acting bearing and a rotation bearing respectively supporting the output shaft in the direct acting direction and the rotation direction. The motor unit is disposed on an anti-load side of the output shaft, and the detector unit is disposed on a load side of the output shaft.

### BRIEF DESCRIPTION OF DRAWINGS

FIG. 1 is a cross-sectional view illustrating a direct acting rotation actuator according to a first embodiment when seen from the side thereof.

FIG. 2A is a (first) cross-sectional view illustrating a field magnet portion according to the first embodiment.

FIG. 2B is a (second) cross-sectional view illustrating the field magnet portion according to the first embodiment.

FIG. 2C is a (third) cross-sectional view illustrating the field magnet portion according to the first embodiment.

FIG. 3 is an exploded diagram illustrating an arrangement relationship between an armature winding and a permanent magnet.

FIG. 4 is a cross-sectional view illustrating a direct acting rotation actuator according to a second embodiment when seen from the side thereof.

FIG. 5 is a cross-sectional view illustrating a motor unit according to the second embodiment when seen from the side thereof.

FIG. 6A is a (first) cross-sectional view illustrating a field magnet portion according to a third embodiment.

FIG. 6B is a (second) cross-sectional view illustrating the field magnet portion according to the third embodiment.

FIG. 6C is a (third) cross-sectional view illustrating the field magnet portion according to the third embodiment.

FIG. 6D is an exploded diagram illustrating the field magnet portion according to the third embodiment.

FIG. 7A is a (first) cross-sectional view illustrating a field magnet portion according to a fourth embodiment.

FIG. 7B is a (second) cross-sectional view illustrating the field magnet portion according to the fourth embodiment.

FIG. 7C is a (third) cross-sectional view illustrating the field magnet portion according to the fourth embodiment.

FIG. 7D is an exploded diagram illustrating the field magnet portion according to the fourth embodiment.

FIG. 8A is a (first) cross-sectional view illustrating a field magnet portion according to a fifth embodiment.

FIG. 8B is a (second) cross-sectional view illustrating the field magnet portion according to the fifth embodiment.

FIG. 8C is a (third) cross-sectional view illustrating a field magnet portion according to a fifth embodiment.

FIG. 8D is an exploded diagram illustrating the field magnet portion according to the fifth embodiment.

### DESCRIPTION OF EMBODIMENTS

Hereinafter, preferred embodiments of a direct acting rotation actuator disclosed in the invention will be described in detail with reference to the accompanying drawings. Furthermore, the following embodiments do not intend to limit the direct acting rotation actuator in the present application.

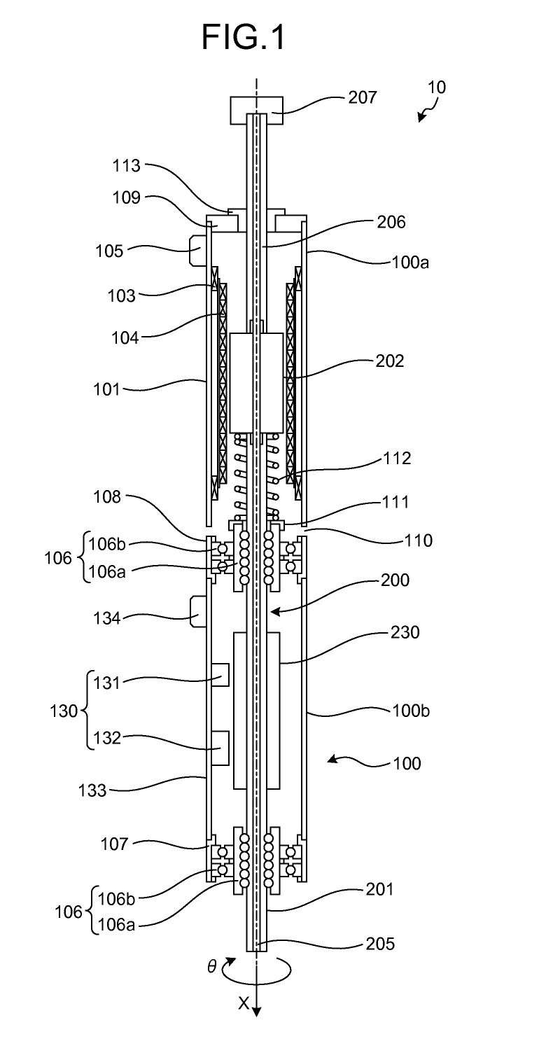

First, a direct acting rotation actuator according to a first embodiment will be described. FIG. 1 is a cross-sectional view illustrating a direct acting rotation actuator 10 according to the first embodiment when seen from the side thereof. Furthermore, the direct acting rotation actuator 10 is provided in such a way that the positive side of the X axis shown in FIG. 1 is set as the lower side of the vertical direction. Hereinafter, a configuration of a stator 100 will be first described.

As shown in FIG. 1, a motor unit 100a of the stator 100 is disposed on an anti-load side, and a detector unit 100b of the stator 100 is disposed on a load side. Furthermore, in the case of FIG. 1, the load side refers to the positive side of the X direction (the direction depicted by the arrow in FIG. 1) shown in FIG. 1, and the anti-load side refers to the negative side of the X direction. Hereinafter, in the case of simple description of the “X direction,” the positive direction and the negative direction are included in that meaning. In addition, the “X direction” corresponds to the “direct acting direction” of the direct acting rotation actuator 10.

The motor unit 100a provided on the anti-load side includes a cylindrical motor frame 101 which doubles as an armature core, a θ armature winding 103, and an X armature winding 104, where these parts are concentrically provided. Further, the motor frame 101 includes a motor terminal 105 which supplies the θ armature winding 103 and the X armature winding 104 with power from an external power supply.

The motor frame 101 includes an end bracket 109 which is disposed on the anti-load side. Then, the end bracket 109 includes an end bush 113 which is a sliding bearing.

The detector unit 100b disposed on the load side includes a detector frame 133 and a direct acting rotation detector 130. Then, the direct acting rotation detector 130 includes a rotation detector 131 and a direct acting detector 132. Further, the detector frame 133 includes a detector terminal 134 which supplies power from an external power supply to the direct acting rotation detector 130 and outputs a detection signal with respect to the angle θ and the position X.

The detector frame 133 includes a load-side bracket 107 which is disposed on the load side and an anti-load-side bracket 108 which is disposed on the anti-load side. Further, each of the load-side bracket 107 and the anti-load-side bracket 108 includes a θX bearing portion 106 having one ball spline 106a and two bearings 106b.

Furthermore, an air gap 110 is provided between the motor unit 100a and the anti-load-side bracket 108 of the detector unit 100b, and the motor unit 100a and the anti-load-side bracket 108 are respectively supported by a fixed base (not shown).

Next, the configuration of a mover 200 will be described. The mover 200 includes an output shaft 201, a field magnet portion 202, an anti-load-side shaft 206. The output shaft 201 is made of a non-magnetic material (for example, stainless steel).

Here, the output shaft 201 is supported to be movable in the X direction through the ball splines 106a provided at two positions, that is, on the load side and on the anti-load side. Further, the output shaft 201 and the ball spline 106a are supported to be rotatable in the positive direction and the negative direction in the θ direction (refer to the arc arrow of FIG. 1) through the bearing 106b. Furthermore, hereinafter, in the case of simple description of the “θ direction,” the positive direction and the negative direction are included in that meaning. Then, the “θ direction” corresponds to the “rotation direction” of the direct acting rotation actuator 10.

In this manner, the output shaft 201 is movable in the θ direction and the X direction with respect to the stator 100. Here, since a load (not shown) is present at the front end of the output shaft 201, the output shaft 201 may freely move the load in the θ direction and the X direction. Then, the output shaft 201 includes a cylindrical direct acting rotation scale 230.

Here, the output shaft 201, the field magnet portion 202 and the anti-load-side shaft 206 are provided with a hollow hole 205 that passes through them from the load side to the anti-load side. Furthermore, the close contact surface between the output shaft 201 and the field magnet portion 202 and the close contact surface between the field magnet portion 202 and the anti-load-side shaft 206 are respectively provided with O-rings (not shown) which are sealing parts.

Further, a joint 207 is provided for a mover 200 on the anti-load side to be rotatable together with the mover 200. Then, a plate 111 is provided in the ball spline 106a of the anti-load-side bracket 108, and the plate 111 rotates together with the mover 200.

Furthermore, between the plate 111 and the field magnet portion 202 is provided an elastic spring 112 that has spring tension in balance with the sum of the weight of the mover 200 and the weight of the load.

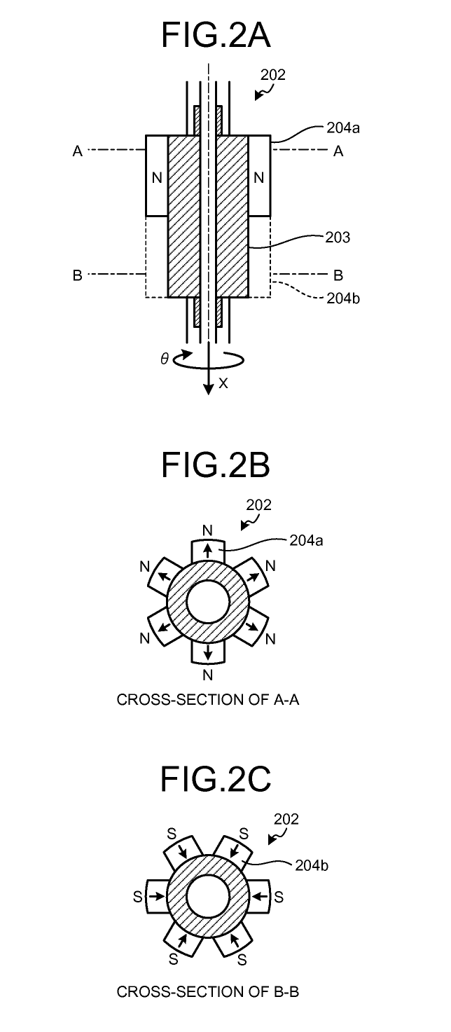

Next, the configuration of the field magnet portion 202 will be described with reference to FIGS. 2A, 2B, and 2C. FIGS. 2A to 2C are (first to third) cross-sectional views respectively illustrating the field magnet portion 202 according to the first embodiment. Furthermore, FIG. 2A is a cross-sectional view illustrating the field magnet portion 202 when seen from the side thereof, FIG. 2B is a cross-sectional view taken along the line A-A of FIG. 2A, and FIG. 2C is a cross-sectional view taken along the line B-B of FIG. 2A.

Further, the arrows “→” shown in FIGS. 2B and 2C indicate the magnetization direction of the permanent magnet, and the polarity thereof is “S→N.”

As shown in FIG. 2A, the field magnet portion 202 includes block magnets 204a and 204b, that is, plural block-shaped permanent magnets (hereinafter, referred to as “block magnets”) provided in the outer periphery of a cylindrical field magnet yoke 203.

Further, as shown in FIG. 2B, the outer peripheral side of the block magnet 204a is magnetized to the N pole, and the inner peripheral side thereof is magnetized to the S pole. As shown in FIG. 2C, the block magnet 204b is reversely magnetized with respect to the block magnet 204a.

Then, the block magnet 204a and the block magnet 204b are arranged in such a way that the convex portions on the outer peripheral portions of them are deviated from each other (in the case of FIGS. 2B and 2C, they are deviated from each other at a pitch of 30° about the output shaft 201 (refer to FIG. 1)). Furthermore, each of the block magnet 204a and the block magnet 204b faces the X armature winding 104 (refer to FIG. 1) with a predetermined air gap interposed between the X armature winding and itself.

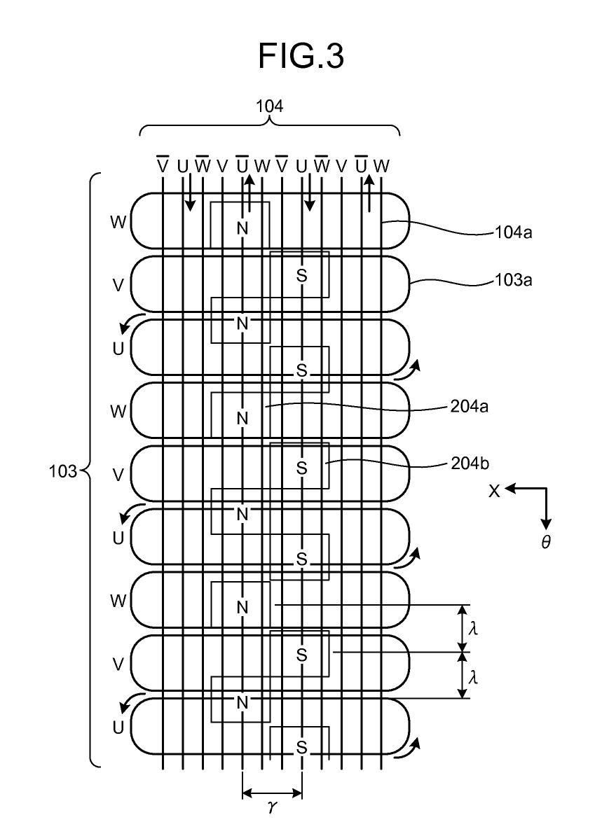

Next, the arrangement relationship between the X armature winding 104 and the permanent magnet (the block magnet 204a and the block magnet 204b) will be described with reference to FIG. 3. FIG. 3 is an exploded diagram illustrating the arrangement relationship between the X armature winding 104 and the permanent magnet according to the first embodiment.

Each group of the block magnet 204a and the block magnet 204b includes six block magnets. The block magnets 204a are arranged at a pitch of 2λ (λ is a polar pitch in θ-direction=an electrical angle of 180°) in the θ direction, and in the same manner, the block magnets 204b are arranged at a pitch of 2λ in the θ direction.

Furthermore, the block magnets 204a and the block magnets 204b are arranged to be deviated from each other by λ in the θ direction and by y in the X direction (γ is a polar pitch in the X-direction polar pitch=an electrical angle of 180°). Accordingly, the number of magnetic poles of the field magnet is twelve in the θ direction, and is two in X direction.

The θ armature winding 103 and the X armature winding 104 are arranged in accordance with the arrangement schematically shown in FIG. 3 with a predetermined air gap with respect to the block magnet 204a and the block magnet 204b. The θ armature winding 103 includes twelve centrally wound coils each having a circular-arc-shaped coil end portion (hereinafter, referred to as “outer-shaped coil 103a”) in total, where three outer-shaped coils are provided for each of the U-phase, the V-phase, and the W-phase.

Here, the pitch of the outer-shaped coils 103a in the θ direction is λ×4/3 (an electrical angle of 240°). Then, since the pitch of the outer-shaped coils 103a for each phase has an electrical angle of 720°, the outer-shaped coils 103a for three phases are wired so as to have the same current direction.

On the other hand, the X armature winding 104 includes, in total, twelve centrally wound annular coils 104a each having a cylindrical shape, where the wound coils are provided for each of the U-phase, the V-phase, and the W-phase. The pitch of the annular coils 104a in the X direction is γ/3 (an electrical angle of 60°), and the entire length of the X armature winding 104 in the X direction is 4γ (=γ/3×12 units).

Since the pitch of the annular coils 104a for the same phase is γ (an electrical angle of 180°), four annular coils 104a for the same phase are wired in such a way that the directions of current are in this order of the positive direction, the reverse direction, the positive direction, and the reverse direction.

The direct acting rotation actuator 10 with such a configuration generates a torque in the mover 200 by the interaction between the current flowing through the θ armature winding 103 and a magnetic field formed by the block magnet 204a and the block magnet 204b. Further, the direct acting rotation actuator generates a thrust force in the mover 200 by the interaction between the current flowing through the X armature winding 104 and the magnetic field formed by the block magnet 204a and the block magnet 204b.

Furthermore, FIG. 3 illustrates a case where a current flows through each of the θ armature winding 103 and the X armature winding 104 so that the U-phase becomes maximal. In this case, since the current flows in the direction depicted by the arrow, the Lorentz force is generated. Then, in the mover 200, a torque is generated in the +θ direction (the positive direction of the θ direction), and a thrust force is generated in the +X direction (the positive direction of the X direction).

Likewise, the direct acting rotation actuator 10 directly generates a torque and a thrust force in the mover 200, whereby a rotation operation and a direct acting operation are performed.

Further, the detector unit 100b (refer to FIG. 1) includes a direct acting rotation scale 230 including a magnetic body which is uneven in the direct acting direction and a magnetic body which is uneven in the rotation direction, where the direct acting rotation scale 230 is provided near the mover 200. In addition, the detector unit 100b includes the direct acting rotation detector 130 in which an exciting winding and a detecting winding for the direct acting direction and the rotation direction are disposed to face each other, and the direct acting rotation detector 130 is disposed near the stator 100.

That is, the detector unit 100b detects the position in the direct acting direction and the angle in the rotation direction by using a direct acting rotation resolver that is configured as the combination of the direct acting rotation scale 230 and the direct acting rotation detector 130.

Furthermore, a detector unit 100b may be configured in such a manner that a plurality of detecting magnets are provided in the mover 200 and three hall elements are provided in the stator 100 facing the mover 200, and may detect the position in the direct acting direction and the angle in the rotation direction.

Likewise, in the direct acting rotation actuator 10 according to the first embodiment, the detector unit 100b is disposed on the load side, the motor unit 100a is disposed on the anti-load side, and the end bush 113 is disposed on the anti-load side of the motor unit 100a.

That is, since the detector unit 100b is disposed on the load side, the distance between the load and the detector unit 100b may be short. Accordingly, as for the load, detection of the position in the direct acting direction and the position in the rotation direction may be performed in the vicinity of the load.

Here, when a current flows through the θ armature winding 103 or the X armature winding 104, heat is generated in the motor unit 100a, and thus the output shaft 201 thermally expands due to the generated heat. However, as described above, if the distance between the load and the detector unit 100b is short, the detector unit 100b is not nearly influenced by the thermal deformations of the output shaft 201 in the direct acting direction and the rotation direction.

Accordingly, since positional errors of the output shaft 201 in the direct acting direction and in the rotation direction may be reduced, the detector unit 100b may detect, with high precision, the position in the direct acting direction and the position in the rotation direction.

Further, in the direct acting rotation actuator according to the first embodiment 10, the θX bearing portion 106 includes one ball spline 106a and two bearings 106b, and the θX bearing portion 106 is disposed at each of both ends of the detector unit 100b.

Likewise, when the θX bearing portion 106 is disposed at each of both ends of the detector unit 100b, the rattling or the eccentric degree of the output shaft 201 of the detector unit 100b may be reduced, and precision in the rotation deviation and straightness of the output shaft 201 may be improved.

Then, since precision in the rotation deviation and straightness of the direct acting rotation scale 230 disposed in the output shaft 201 may be improved in accordance with the improvement in precision in the rotation deviation and straightness of the output shaft 201, the detector unit 100b may detect, with high precision, the position in the direct acting direction and the angle in the rotation direction.

Further, in the direct acting rotation actuator 10, since the end bush 113 is disposed on the anti-load side of the motor unit 100a, the rattling or the eccentric degree of the field magnet portion 202 may be reduced, and further the rattling or the eccentric degree of the output shaft 201 may be reduced. Accordingly, precision in the rotation deviation and straightness of the output shaft 201 may be improved.

Furthermore, the direct acting rotation actuator 10 has the air gap 110 between the motor unit 100a and the detector unit 100b. As such, if the air gap 110 is provided between the motor unit 100a and the detector unit 100b provided with the anti-load-side bracket 108, such a configuration may make it difficult for the heat generated from the motor unit 100a to be transferred to the detector unit 100b. Accordingly, a detection error of the detector unit 100b which occurs with an increase in the temperature may be reduced.

The direct acting rotation actuator 10 includes the mover 200 in which the output shaft 201 provided with the direct acting rotation scale 230 and the field magnet portion 202 are separately provided. This allows a reduction in the length of the output shaft 201 and an improvement in precision in the rotation deviation and straightness of the output shaft 201. Here, since the output shaft 201 is configured with the use of the ball spline shaft which is formed by precise processing, if the length of the output shaft 201 is shortened, the output shaft 201 may be manufactured at low cost.

Further, in assembling the field magnet portion 202, it is necessary to carefully handle the block magnets 204a and 204b which are magnetized. In assembling the output shaft 201, it is necessary to carefully attach the direct acting rotation scale 230, taking the detection precision of the direct acting rotation into account. Therefore, as described above, if the output shaft 201 and the field magnet portion 202 are divided from each other in the above described a manner, the field magnet portion 202 and the output shaft 201 may be assembled through separate assembly processes, whereby the assembly work is easy.

Furthermore, the direct acting rotation actuator 10 includes the output shaft 201 that is made of a non-magnetic material (for example, stainless steel). Likewise, when the output shaft 201 is made of a non-magnetic material, the output shaft 201 does not permit transmission of magnetic flux. Here, if the output shaft 201 is made of a magnetic material, the magnetic field lines in the magnetic flux leaking from the field magnet portion 202 may contain some magnetic field lines that pass through the output shaft 201 and are thus continuous to the detector unit 100b.

Therefore, as described above, if the output shaft 201 is made of a non-magnetic material, magnetic flux does not pass through the output shaft 201, whereby the leaking magnetic flux impinging to the detector unit 100b may be reduced. Accordingly, the detection error of the detector unit 100b caused by the leaking magnetic flux of the field magnet portion 202 may be reduced.

Further, the direct acting rotation actuator 10 includes the output shaft 201 provided with the hollow hole 205. Likewise, if the hollow hole 205 is provided in the output shaft 201, air (refrigerant) may travel through the hollow hole 205 by way of the joint 207, whereby the output shaft 201 may be cooled.

As described above, since the output shaft 201 thermally expands due to the heat generated from the motor unit 100a, if the output shaft 201 is cooled in this manner, the thermal deformation of the output shaft 201 in the direct acting direction may be reduced, and specifically the positional error of the output shaft 201 in the direct acting direction may be reduced.

Then, since the hollow hole 205 may be forced to enter a vacuum state by way of the joint 207, parts may be attached by suction to the load-side front end of the output shaft 201. Further, since the hollow hole 205 may be used as a pressure hole by way of the joint 207, parts may be detached from the load-side front end of the output shaft 201.

Further, the direct acting rotation actuator 10 includes the elastic spring 112 between the plate 111 and the field magnet portion 202. With this configuration, when power is not supplied to the θ armature winding 103 and the X armature winding 104, the mover 200 may stop at a position where the sum of the weights of the mover 200 and the load is in balance with the tension of the elastic spring 112.

Furthermore, since the mover 200 may be prevented from being dropped, it may be possible to prevent the degradation in the part precision and position precision of the output shaft 201 caused by collision with the load or other external objects.

Moreover, since the plate 111 is disposed in the ball spline 106a, the plate 111 may rotate in accordance with the field magnet portion 202, and the elastic spring 112 may rotate in accordance with the field magnet portion 202.

Here, if a configuration is adopted in which the elastic spring 112 may not rotate in accordance with the field magnet portion 202, the elastic spring 112 is distorted, and a torque attributable to the distortion is generated between the plate 111 and the field magnet portion 202 and is transmitted to the output shaft 201. For this reason, the precise rotation operation may not be performed.

Therefore, when the elastic spring 112 rotates in accordance with the field magnet portion 202, a torque attributable to the distortion of the elastic spring 112 may not be transmitted to the output shaft 201. Further, since the elastic spring 112 is disposed between the plate 111 and the field magnet portion 202, the internal space of the stator 100 may be used, and thus the actuator may be decreased in the size.

As described above, in the direct acting rotation actuator according to the first embodiment, the motor unit is disposed on the anti-load side of the output shaft, and the detector unit is disposed on the load side of the output shaft. Likewise, if the distance between the load and the detector unit is short, the thermal deformation of the output shaft in the direct acting direction and the rotation direction may be reduced, and the positional error of the output shaft in the direct acting direction and the rotation direction may be reduced. Accordingly, the position in the direct acting direction and the angle in the rotation direction may be detected with high precision.

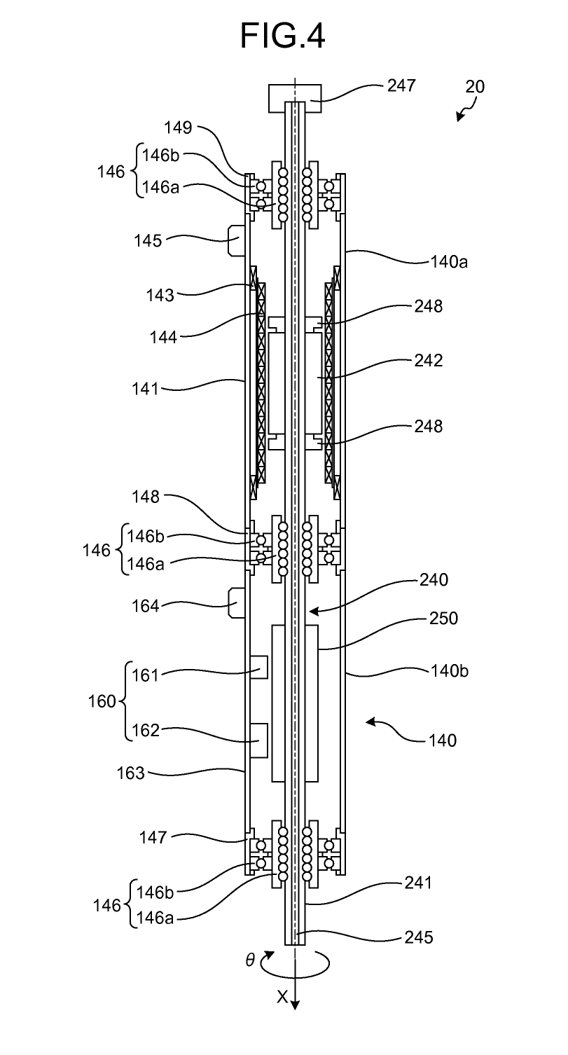

Next, a direct acting rotation actuator according to a second embodiment will be described. FIG. 4 is a cross-sectional view illustrating a direct acting rotation actuator 20 according to the second embodiment when seen from the side thereof. Furthermore, the direct acting rotation actuator 20 is provided in such a way that the positive side of the X axis shown in FIG. 4 is set as the lower side of the vertical direction. Hereinafter, the configuration of a stator 140 will be first described.

Here, a motor unit 140a of the stator 140 is disposed on the anti-load side, and a detector unit 140b of the stator 140 is disposed on the load side. Furthermore, in the case of FIG. 4, the load side corresponds to the positive side of the X direction (the direction depicted by the arrow in FIG. 4) shown in FIG. 4, and the anti-load side corresponds to the negative side of the X direction. Hereinafter, in the case of simple description of the “X direction,” the positive direction and the negative direction are included in that meaning.

The motor unit 140a provided on the anti-load side includes a cylindrical motor frame 141 which doubles as an armature core, a θ armature winding 143, and an X armature winding 144, where these parts are concentrically provided. Further, the motor frame 141 includes a motor terminal 145 which supplies the θ armature winding 143 and the X armature winding 144 with power from an external power supply. Furthermore, the motor frame 141 includes an end bracket 149 on the anti-load side.

The detector unit 140b provided on the anti-load side includes a detector frame 163 and a direct acting rotation detector 160. Then, the direct acting rotation detector 160 includes a rotation detector 161 and a direct acting detector 162. Further, the detector frame 163 includes a detector terminal 164 which supplies the direct acting rotation detector 160 with power from an external power supply, and outputs a detection signal related to the angle θ and the position X.

The detector frame 163 includes a load-side bracket 147 which is disposed on the load side and an anti-load-side bracket 148 which is disposed on the anti-load side. Further, each of the load-side bracket 147, the anti-load-side bracket 148, and the end bracket 149 includes a θX bearing portion 146 having one ball spline 146a and two bearings 146b.

Furthermore, the motor frame 141 is supported by the anti-load-side bracket 148 so that the motor unit 140a and the detector unit 140b may be integrated.

Next, a configuration of a mover 240 will be described. The mover 240 includes an output shaft 241 and a field magnet portion 242. Further, the field magnet portion 242 and the output shaft 241 are integrated.

Here, the output shaft 241 is supported to be movable in the X direction through the ball splines 146a provided at three positions. Further, the output shaft 241 and the ball spline 146a are supported to be rotatable in the positive direction and the negative direction of the θ direction (refer to the arc arrow of FIG. 4) through the bearing 146b. Furthermore, hereinafter, in the case of simple description of the “θ direction,” the positive direction and the negative direction are included in that meaning.

Likewise, the output shaft 241 is movable in the θ direction and the X direction with respect to the stator 140. Here, since a load (not shown) is present at the front end of the output shaft 241, the output shaft 241 may freely move the load in the θ direction and the X direction. Then, the output shaft 241 includes a cylindrical direct acting rotation scale 250.

Here, the output shaft 241 is provided with a hollow hole 245 which passes itself from the load side to the anti-load side. Further, a joint 247 is provided on the anti-load side of the mover 240 to be rotatable along with the mover 240. Then, an interpole yoke 248 is provided at each of both ends of the field magnet portion 242, where the interpole yoke is made of an annular magnetic material.

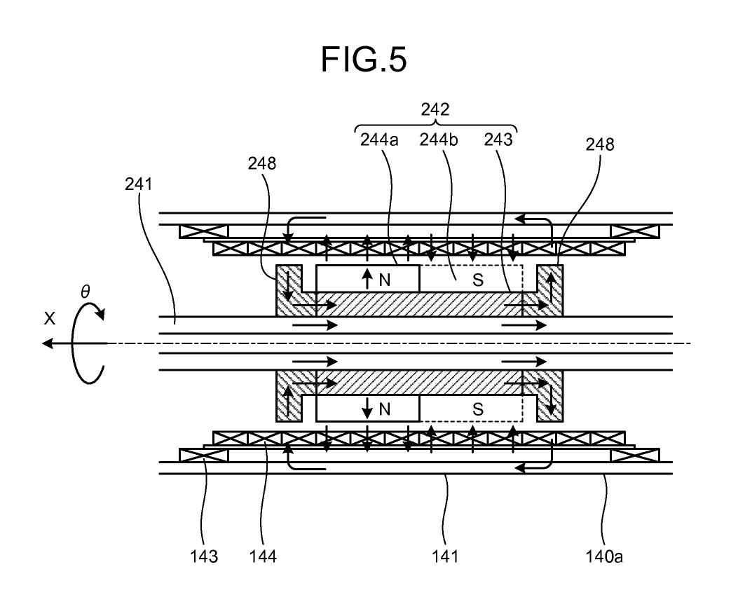

Next, the motor unit 140a will be described in more detail with reference to FIG. 5. FIG. 5 is a cross-sectional view illustrating the motor unit 140a according to the second embodiment when seen from the side thereof. Here, as described above, the motor unit 140a includes the cylindrical motor frame 141 which doubles as an armature core, the θ armature winding 143, and the X armature winding 144, where these parts are concentrically provided. Furthermore, the arrow “→” shown in FIG. 5 indicates the direction of the magnetic field line, and the polarity is “S→N.”

As shown in FIG. 5, the field magnet portion 242 includes block magnets 244a and 244b which are provided on the outer peripheral side of a cylindrical field magnet yoke 243. Furthermore, the outer peripheral side of the block magnet 244a is magnetized to the N pole, and the inner peripheral side thereof is magnetized to the S pole. The block magnet 244b is reversely magnetized with respect to the magnetization of the block magnet 244a. In addition, the interpole yoke 248 is provided at each of both ends of the field magnet portion 242, where the interpole yoke is made of an annular magnetic material.

Likewise, the direct acting rotation actuator 20 according to the second embodiment is different from the direct acting rotation actuator according to the first embodiment 10 in that, on the anti-load side of the motor unit 140 are provided the θX bearing portion 146 and the interpole yoke 248.

That is, since the direct acting rotation actuator 20 according to the second embodiment includes the θX bearing portion 146 on the anti-load side of the motor unit 140a, the direct acting rotation actuator 20 may further reduce the rattling or the eccentric degree of the field magnet portion 242 and reduce the rattling or the eccentric degree of the output shaft 241 compared to the direct acting rotation actuator according to the first embodiment 10. Accordingly, precision in the rotation deviation and straightness of the output shaft 241 may be further improved.

Here, if the interpole yoke 248 is not provided, the magnetic field lines originating from the magnetic flux leaking from the field magnet portion 242 may contain some magnetic field lines that pass through the motor frame 141 and are thus continuous to the detector unit 140b or continuous to the detector unit 140b.

Therefore, as described above, when the annular interpole yoke 248 is provided at each of both ends of the field magnet portion 242, the magnetic field line originating from the leaking magnetic flux of the field magnet portion 242 is formed as the magnetic field line that passes through the motor frame 141, and passes through the output shaft 241 by way of the interpole yoke 248. Accordingly, the leaking magnetic flux directed to the detector unit 140b may be reduced, and the detection error of the detector unit 140b caused by the leaking magnetic flux of the field magnet portion 242 may be reduced.

Furthermore, the interpole yoke 248 may be formed in a petal shape (not shown) that is uneven in the rotation direction. Furthermore, although the interpole yoke 248 is provided at each of both ends of the field magnet portion 242 so that the leaking magnetic flux at both ends of the field magnet portion 242 may become the same on the load side and on the anti-load side, the interpole yoke 248 may be provided at one end of the field magnet portion 242, for example, only on the load side.

In the above-described first and second embodiments, a configuration has been exemplified in which the field magnet portion is provided on the mover side of the motor unit (for example, refer to FIG. 2A or 5), the configuration of the field magnet portion is not limited to the example. Therefore, hereinafter, other configuration examples of the field magnet portion will be described with reference to a third embodiment, a fourth embodiment, and a fifth embodiment. Furthermore, hereinafter, as in the first embodiment, the field magnet portion is described as the field magnet portion 202.

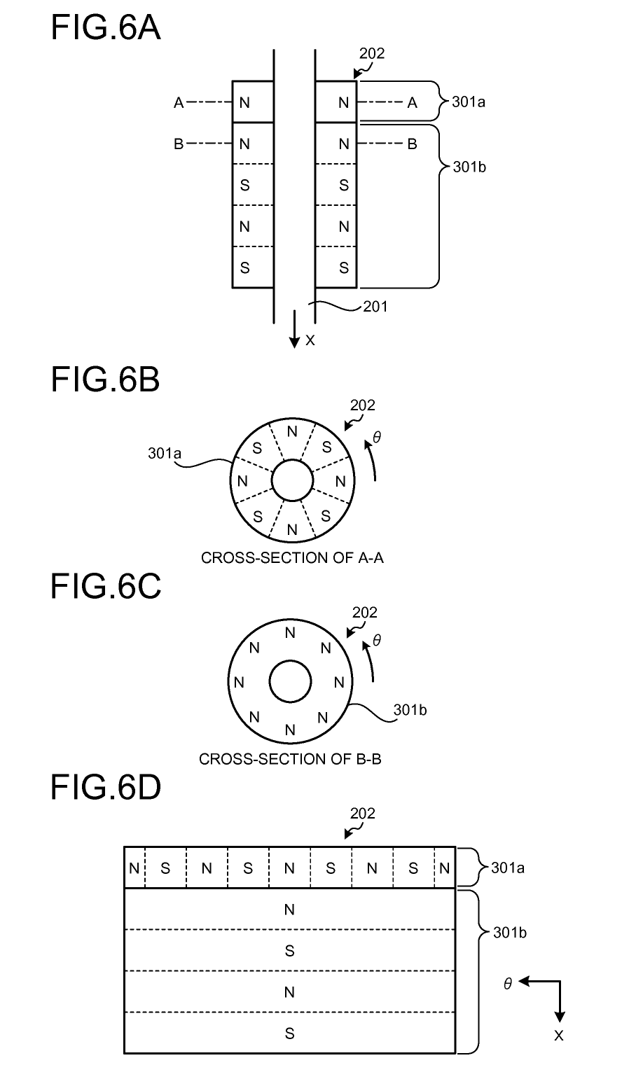

The configuration of the field magnet portion 202 according to the third embodiment will be described with reference to FIGS. 6A, 6B, 6C, and 6D. FIGS. 6A to 6C are (first to third) cross-sectional views illustrating the field magnet portion 202 according to the third embodiment, and FIG. 6D is an exploded diagram illustrating the field magnet portion 202 according to the third embodiment. Furthermore, FIG. 6D is an exploded diagram when seen from the outer peripheral side of the field magnet portion.

Further, FIG. 6A is a cross-sectional view illustrating the field magnet portion 202 when seen from the side thereof, FIG. 6B is a cross-sectional view taken along the line A-A of FIG. 6A, and FIG. 6C is a cross-sectional view taken along the line B-B of FIG. 6A.

As shown in FIGS. 6A and 6B, the field magnet portion 202 according to the third embodiment includes an annular magnet 301a which is an annular permanent magnet alternately repeating the N and S poles at the outer peripheral side of the rotation direction (the θ direction). Further, as shown in FIGS. 6A and 6C, the field magnet portion 202 according to the third embodiment includes an annular magnet 301b alternately repeating the N and S poles at the outer peripheral side of the direct acting direction (the X direction).

Then, as shown in FIG. 6A, the annular magnet 301a and the annular magnet 301b are coaxially disposed along the output shaft 201. Furthermore, the annular magnet 301a and the annular magnet 301b are fixed to each other by bonding or the like.

Furthermore, the annular magnet 301a and the annular magnet 301b may be formed as one member, and may be magnetized after they are formed. Likewise, when the annular magnet 301a and the annular magnet 301b are integrated, the number of assembling processes may be reduced, or the precision of the part may be further improved.

As shown in FIG. 6B, the annular magnet 301a includes a portion having an outer peripheral side magnetized to the N pole and a portion having an outer peripheral side magnetized to the S pole in the cross-section (the cross-section of A-A) taken along the line A-A of FIG. 6A, where these portions respectively magnetized to the N and S poles are alternately arranged at the same interval with respect to the θ direction (the rotation direction).

Furthermore, in FIG. 6B, a case has been exemplified in which the N and S poles are eight in total, but the number of poles may be arbitrarily set. In addition, the portions having the outer peripheral sides respectively magnetized to the N and S poles may be arranged at different intervals with respect to the θ direction (the rotation direction).

Likewise, the annular magnet 301a alternately repeats the N and S poles in the rotation direction. Accordingly, when a current flows through the θ armature winding 103 (refer to FIG. 1), a torque is generated in the mover 200 (refer to FIG. 1) due to the interaction between the current with the magnetic field formed by the annular magnet 301a.

Further, as shown in FIG. 6C, the annular magnet 301b has an outer peripheral side magnetized to the N pole in the cross-section (the cross-section of B-B) taken along the line B-B shown in FIG. 6A. Then, as shown in FIG. 6D, the annular magnet 301b alternately repeats the portions having outer peripheral sides respectively magnetized to the N and S poles at the same interval with respect to the X direction (the direct acting direction).

Accordingly, when a current flows through the X armature winding 104 (refer to FIG. 1), a thrust force is generated in the mover 200 (refer to FIG. 1) due to the interaction between the current and the magnetic field formed by the annular magnet 301b.

Furthermore, in FIG. 6D, a case has been exemplified in which the number of the repeated N and S poles in the annular magnet 301b is four, but the number may be arbitrarily set. In addition, the annular magnet 301b may be formed in a manner such that the portions having the outer peripheral sides respectively magnetized to the N and S poles are arranged at different intervals with respect to the X direction (the direct acting direction).

Likewise, according to the field magnet portion 202 of the third embodiment, since the annular magnet 301a and the annular magnet 301b are coaxially disposed, the structure of the field magnet portion 202 may be simplified, and the precision of the field magnet portion 202 may be improved.

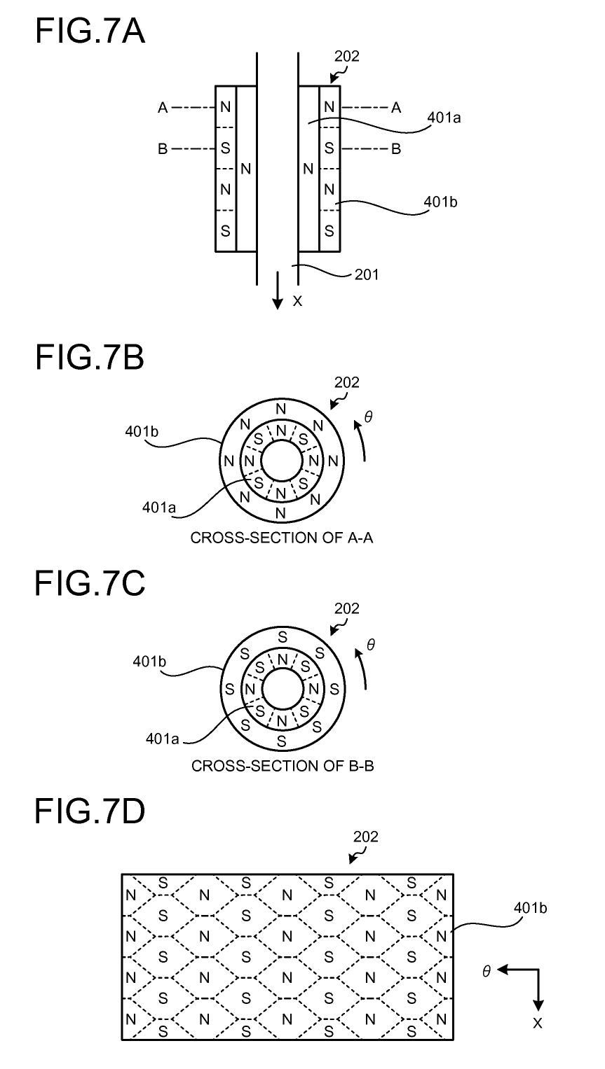

The configuration of the field magnet portion 202 according to the fourth embodiment will be described with reference to FIGS. 7A, 7B, 7C, and 7D. FIGS. 7A to 7C are (first to third) cross-sectional views illustrating the field magnet portion 202 according to the fourth embodiment, and FIG. 7D is an exploded diagram illustrating the field magnet portion 202 according to the fourth embodiment. Furthermore, FIG. 7D is an exploded diagram when seen from the outer peripheral side of the field magnet portion.

Further, FIG. 7A is a cross-sectional view illustrating the field magnet portion 202 when seen from the side thereof, FIG. 7B is a cross-sectional view taken along the line A-A of FIG. 7A, and FIG. 7C is a cross-sectional view taken along the line B-B of FIG. 7A.

As shown in FIGS. 7A and 7B, the field magnet portion 202 according to the fourth embodiment includes an annular magnet 401a alternately repeating the N and S poles at the outer peripheral side thereof in the rotation direction (the θ direction). Further, as shown in FIGS. 7A and 7C, the field magnet portion 202 according to the fourth embodiment includes an annular magnet 401b alternately repeating the N and S poles at the outer peripheral side in the direct acting direction (the X direction).

Then, as shown in FIGS. 7A to 7C, the annular magnet 401a and the annular magnet 401b are coaxially disposed along the output shaft 201. Furthermore, the annular magnet 401a and the annular magnet 401b are fixed to each other by bonding or the like. Further, in FIGS. 7A to 7C, a case has been exemplified in which the annular magnet 401a is disposed at the inside and the annular magnet 401b is disposed at the outside, but the positional relationship thereof may be reversed.

Furthermore, the annular magnet 401a and the annular magnet 401b are formed as one member, and may be magnetized after they are formed. Likewise, when the annular magnet 401a and the annular magnet 401b are integrated, the number of assembling processes may be reduced, or the precision of the part may be further improved.

As shown in FIG. 7B, the annular magnet 401a includes portions having outer peripheral sides respectively magnetized to the N and S poles alternately arranged at the same interval with respect to the θ direction (the rotation direction) in the cross-section (the cross-section of A-A) taken along the line A-A.

As shown in FIG. 7C, the cross-section of B-B of the annular magnet 401a is the same as the cross-section of A-A. That is, the annular magnet 401a is magnetized in the X direction (the direct acting direction) in the same manner as that of the cross-section of A-A.

Furthermore, in FIGS. 7B and 7C, a case has been described in which the N and S poles in the annular magnet 401a are eight in total, but the number of the poles may be arbitrarily set. In addition, the portions having the outer peripheral sides respectively magnetized to the N and S poles may be arranged at different intervals with respect to the θ direction (the rotation direction).

Likewise, the annular magnet 401a alternately repeats the N and S poles in the rotation direction. Accordingly, when a current flows through the θ armature winding 103 (refer to FIG. 1), a torque is generated in the mover 200 (refer to FIG. 1) due to the interaction between the current and the magnetic field formed by the annular magnet 401a. Furthermore, the magnetic field formed by the annular magnet 401a is synthesized with the magnetic field formed by the annular magnet 401b, but this will be described later with reference to FIG. 7D.

Further, as shown in FIG. 7B, the outer peripheral side of the annular magnet 401b is magnetized to the N pole in the cross-section (the cross-section of A-A) taken along the line A-A shown in FIG. 7A. In addition, as shown in FIG. 7C, the outer peripheral side of the annular magnet 401b is magnetized to the S pole in the cross-section (the cross-section of B-B) taken along the line B-B shown in FIG. 7A.

Then, as shown in FIGS. 7A to 7C, the annular magnet 401b alternately repeats the portions having the outer peripheral sides respectively magnetized to the N and S poles at the same interval with respect to the X direction (the direct acting direction).

Accordingly, when a current flows through the X armature winding 104 (refer to FIG. 1), a thrust force is generated in the mover 200 (refer to FIG. 1) due to the interaction between the current and the magnetic field formed by the annular magnet 401b. Furthermore, the magnetic field formed by the annular magnet 401b is synthesized with the magnetic field formed by the annular magnet 401a, but this will be described later with reference to FIG. 7D.

As shown in FIG. 7D, the magnetic field formed by the annular magnet 401a and the magnetic field formed by the annular magnet 401b are synthesized in a honeycomb shape. For example, the portion in which the outer peripheral side of the annular magnet 401a is the N pole and the outer peripheral side of the annular magnet 401b is the N pole corresponds to the N pole. Further, the portion in which the outer peripheral side of the annular magnet 401a is the S pole and the outer peripheral side of the annular magnet 401b is the S pole corresponds to the S pole.

Then, the portion in which either one of the outer peripheral side of the annular magnet 401a or the outer peripheral side of the annular magnet 401b is the N pole and the other outer peripheral side is the S pole has the weak polarity because the magnetic fluxes of them become weaker together (refer to the chain line shown in FIG. 7D).

Furthermore, in FIGS. 7A and 7D, a case has been exemplified in which the number of the repeated N and S poles in the annular magnet 401b is four, but the number may be arbitrarily set. In addition, the annular magnet 401b may be formed in a manner such that the portions having the outer peripheral sides respectively magnetized to the N and S poles are arranged at different intervals with respect to the X direction (the direct acting direction).

Likewise, according to the field magnet portion 202 of the fourth embodiment, since the annular magnet 401a and the annular magnet 401b are coaxially disposed, the structure of the field magnet portion 202 may be simplified, and the precision of the field magnet portion 202 may be improved.

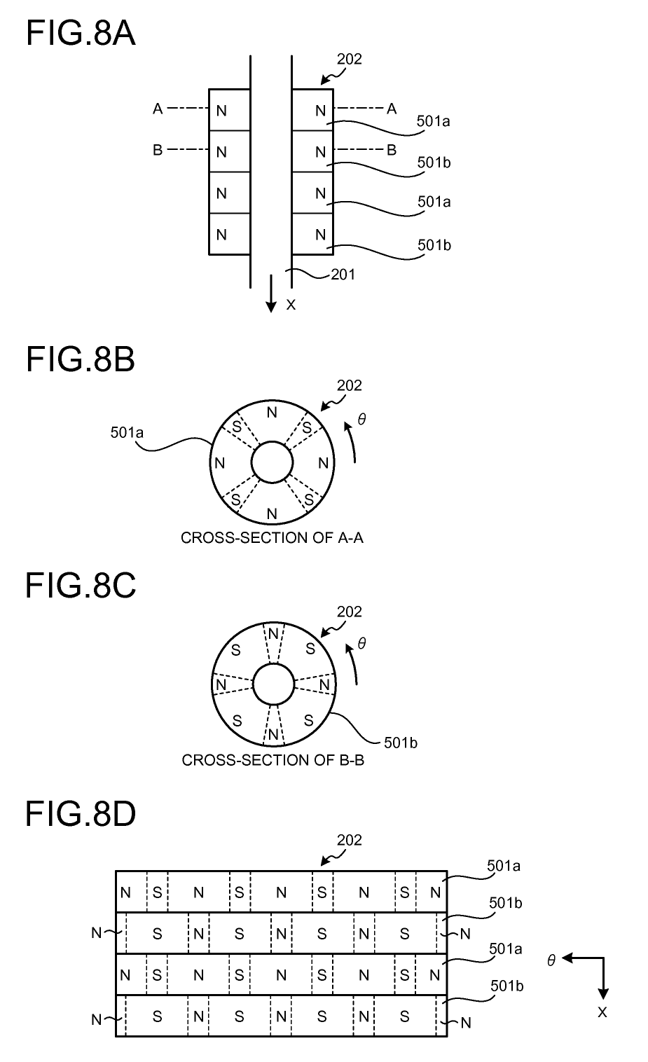

The configuration of the field magnet portion 202 according to the fifth embodiment will be described with reference to FIGS. 8A, 8B, 8C, and 8D. FIGS. 8A to 8C are (first to third) cross-sectional views respectively illustrating the field magnet portion 202 according to the fifth embodiment, and FIG. 8D is an exploded diagram illustrating the field magnet portion 202 according to the fifth embodiment. Furthermore, FIG. 8D is an exploded diagram when seen from the outer peripheral side of the field magnet portion.

Furthermore, FIG. 8A is a cross-sectional view illustrating the field magnet portion 202 when seen from the side thereof, FIG. 8B is a cross-sectional view taken along the line A-A of FIG. 8A, and FIG. 8C is a cross-sectional view taken along the line B-B of FIG. 8A.

As shown in FIGS. 8A and 8B, the field magnet portion 202 according to the fifth embodiment includes an annular magnet 501a alternately repeating the N and S poles at different intervals at the outer peripheral side of the rotation direction (the θ direction). Further, as shown in FIGS. 8A and 8C, the field magnet portion 202 according to the fifth embodiment includes an annular magnet 501b alternately repeating the N and S poles at different intervals at the outer peripheral side in the rotation direction (the θ direction).

Then, the annular magnet 501a and the annular magnet 501b are coaxially provided along the output shaft 201 so that the center portion of the N pole of the annular magnet 501a at the outer peripheral side of the rotation direction (the θ direction) is coincident with the center portion of the N pole of the annular magnet 501b. Furthermore, in FIG. 8A, a case has been exemplified in which the field magnet portion 202 has the same number of annular magnets 501a and 501b, but the number thereof may be arbitrarily set.

Further, in FIG. 8A, a case has been exemplified in which the width of the annular magnet 501a in the X direction (the direct acting direction) is equal to the width of the annular magnet 501b in the X direction (the direct acting direction), but the widths may be different from each other. Furthermore, the annular magnet 501a and the annular magnet 501b are fixed to each other by bonding or the like.

Furthermore, the annular magnet 501a and the annular magnet 501b may be formed as one member, and may be magnetized after they are formed. Likewise, when the annular magnet 501a and the annular magnet 501b are integrated, the number of assembling processes may be reduced, or the precision of the part may be further improved.

As shown in FIG. 8B, the annular magnet 501a alternately includes portions having outer peripheral sides respectively magnetized to the N and S poles at different intervals with respect to the θ direction (the rotation direction) in the cross-section (the cross-section of A-A) taken along the line A-A shown in FIG. 8A. Furthermore, the width of the N pole in the θ direction (the rotation direction) is wider than the width of the S pole.

Likewise, the annular magnet 501a alternately repeats the N and S poles in the rotation direction. Accordingly, when a current flows through the θ armature winding 103 (refer to FIG. 1), a torque is generated in the mover 200 (refer to FIG. 1) due to the interaction between the current and the magnetic field formed by the annular magnet 501a.

Further, as shown in FIG. 8C, the annular magnet 501b includes portions having outer peripheral sides respectively magnetized to the N and S poles at different intervals with respect to the θ direction (the rotation direction) in the cross-section (the cross-section of B-B) taken along the line B-B. Furthermore, the width of the S pole in the θ direction (the rotation direction) is wider than the width of the N pole.

Likewise, the annular magnet 501b alternately repeats the N and S poles in the rotation direction. Accordingly, when a current flows through the θ armature winding 103 (refer to FIG. 1), a torque is generated in the mover 200 (refer to FIG. 1) due to the interaction between the current and the magnetic field formed by the annular magnet 501a and the annular magnet 501b.

Furthermore, in FIGS. 8B and 8C, a case has been exemplified in which the ratio between the widths of the N and S poles in the annular magnet 501a is equal to the ratio between the widths of the S and N poles in the annular magnet 501b, but both ratios may be set to be different.

As shown in FIG. 8D, the annular magnet 501a and the annular magnet 501b have portions repeating the N and S poles in the X direction (the direct acting direction). Accordingly, when a current flows through the X armature winding 104 (refer to FIG. 1), a thrust force is generated in the mover 200 (refer to FIG. 1) due to the interaction between the current and the magnetic field formed by the annular magnet 501a and the annular magnet 501b.

Furthermore, the distribution of the thrust force and the torque generated in the mover 200 (refer to FIG. 1) may be changed by adjusting the ratio between the widths of the N and S poles in the annular magnet 501a and the annular magnet 501b.

Further, the ratio between the respective poles or the relative angle in the θ direction (the rotation direction) of the annular magnet 501a and the annular magnet 501b may be sufficiently realized if the magnets have portions, each repeating the N and S poles in the X direction (the direct acting direction).

Likewise, according to the field magnet portion 202 of the fifth embodiment, since the annular magnet 501a and the annular magnet 501b are coaxially disposed, the structure of the field magnet portion 202 may be simplified, and the precision of the field magnet portion 202 may be improved.

Additional advantages and modifications will readily occur to those skilled in the art. Therefore, the invention in its broader aspects is not limited to the specific details and representative embodiments shown and described herein. Accordingly, various modifications may be made without departing from the spirit or scope of the general inventive concept as defined by the appended claims and their equivalents.

What is claimed is:

1. A direct acting rotation actuator comprising:
a motor unit including a field magnet portion which includes a permanent magnet or a core tooth, a first armature winding which generates a rotation magnetic field in the rotation direction, and a second armature winding which generates a traveling magnetic field in the direct acting direction;
an output shaft which is attached to the field magnet portion of the motor unit;
a detector unit which includes a direct acting detector and a rotation detector respectively detecting a position in the direct acting direction and an angle in the rotation direction of the output shaft; and
a bearing portion which includes a direct acting bearing and a rotation bearing respectively supporting the output shaft in the direct acting direction and the rotation direction,
wherein the motor unit is disposed on an anti-load side of the output shaft, and the detector unit is disposed on a load side of the output shaft.

2. The direct acting rotation actuator according to claim 1,
wherein the bearing portion is disposed at both sides of the detector unit.

3. The direct acting rotation actuator according to claim 1,
wherein an air gap is provided between the motor unit and the detector unit.

4. The direct acting rotation actuator according to claim 1,
wherein the output shaft includes the detector unit and the field magnet portion which are divided from each other.

5. The direct acting rotation actuator according to claim 1,
wherein the output shaft is made of a non-magnetic material.

6. The direct acting rotation actuator according to claim 1,
wherein the output shaft is provided with a hollow hole.

7. The direct acting rotation actuator according to claim 1,
wherein the field magnet portion includes:
a first annular magnet which is multi-polar and alternately magnetized to N and S poles in the rotation direction, and
a second annular magnet which is multi-polar and alternately magnetized to N and S poles in the direct acting direction.

8. The direct acting rotation actuator according to claim 7,
wherein the first annular magnet and the second annular magnet are coaxially disposed.

9. The direct acting rotation actuator according to claim 7,
wherein the first annular magnet and the second annular magnet are concentrically disposed.

10. The direct acting rotation actuator according to claim 7,
wherein the first annular magnet and the second annular magnet are integrally formed with each other.

11. The direct acting rotation actuator according to claim 1,
wherein the field magnet portion includes:
a third annular magnet which is multi-polar and alternately magnetized to N and S poles so that the width of the N pole is wider than the width of the S pole in the rotation direction, and
a fourth annular magnet which is multi-polar and alternately magnetized to N and S poles so that the width of the N pole is narrower than the width of the S pole in the rotation direction.

12. The direct acting rotation actuator according to claim 11,
wherein in the field magnet portion, the third annular magnet and the fourth annular magnet are alternately arranged in the direct acting direction.

13. The direct acting rotation actuator according to claim 11,
wherein the third annular magnet and the fourth annular magnet are integrally formed with each other.

14. The direct acting rotation actuator according to claim 1, further comprising:
an elastic spring which is provided between the field magnet portion and the direct acting bearing and rotates in accordance with the rotation of the field magnet portion.

15. The direct acting rotation actuator according to claim 1,
wherein the field magnet portion includes an annular interpole yoke at both ends thereof in the direct acting direction.

16. The direct acting rotation actuator according to claim 2,
wherein the bearing portion is disposed on the anti-load side of the motor unit.
